(19) United States
(12) Patent Application Publication
(10) Pub. No.: US 2005/0281438 A1
(43) Pub. Date: Dec. 22, 2005

(54) Palm print identification using palm line orientation

(76) Inventors: David Dapeng Zhang, Hong Kong (HK); Wai Kin Adams Kong, Hong Kong (HK)

Correspondence Address: JACKSON WALKER L.L.P.;Suite 2100, 112 E. Pecan Street, San Antonio, TX, 78205, US

(21) Appl. No.: 10/872,878

(22) Filed: Jun. 21, 2004

(51) Int. Cl. G06K 9/00

(52) U.S. Cl. 382/115

(57) ABSTRACT

A method of biometrics identification involves obtaining an image of a portion of a hand of an individual, said image including a plurality of line features of the hand, analyzing the image to obtain a characteristic value including orientation information of said line features in two or more orientations, and comparing the characteristic value with reference information in a database. The analyze use a neurophysiology-based Gabor.

### BACKGROUND TO THE INVENTION

1. Field of the Invention

The invention relates to biometrics identification, and in particular to a method for analyzing a palm print for the identification of an individual.

2. Background Information

Computer-aided recognition of individuals is becoming increasingly important in our information society. Biometrics is one of the most important and reliable methods in this field. The most widely used biometric feature is the fingerprint, whereas the most reliable feature is the iris. However, it is very difficult to extract small unique features (known as minutiae) from unclear fingerprints and iris scanners are very expensive. Other biometric features, such as the face and voice, are less accurate and they can be mimicked easily.

Palm print recognition for personal identification is becoming increasingly popular. Known methods include analyzing an image of a palm print to identify singular points, wrinkles, delta points and minutiae in the palm print. However, this requires a high-resolution image. Palm print scanners that capture high-resolution images are costly and rely on high performance computers to fulfill the requirements of real-time identification.

One solution to the above problems seems to be the use of low-resolution images. In low-resolution palm print images, however, singular points and minutiae cannot be observed easily and only a small proportion of wrinkles are significantly clear. This makes it is questionable whether the use of such features from low resolutions provide sufficient distinctiveness to reliably identify individuals amongst a large population.

### SUMMARY OF THE INVENTION

It is an object of the present invention to provide a method of biometrics identification, and in particular a method for analyzing a palm print for the identification of an individual, which overcomes or ameliorates the above problems.

According to the invention there is a method of biometrics identification involves obtaining an image of a portion of a hand of a subject, said image including a line feature of the hand, analyzing the image to obtain a characteristic value including orientation information of said line features in two or more orientations, and comparing the characteristic value with reference information in a database. The analyze use a neurophysiology-based Gabor.

Analyzing the image includes creating a model of the line feature, applying a Gabor function to the model to extract properties of the line feature, and applying a rule to the properties to obtain the orientation information.

Comparing the characteristic value with reference information includes calculating an angular distance between the characteristic value and reference information.

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 is an equation for a neurophysiology-based Gabor function,

FIG. 2 is an equation defining κ in FIG. 1.

FIG. 3 is an equation of an idea palm line model,

FIG. 4 is the neurophysiology-based Gabor function for the line xcosθ_{L}+ysinθ_{L}=0,

FIG. 5 illustrates orientation lines obtained using a method of the invention.

FIG. 6 is a first equation for finding the angular distance,

FIG. 7 is a table of bit values among different elements of Competitive Code,

FIG. 8 is a first equations for finding the angular distance, and

FIG. 9 is a graph a plot of the genuine acceptance rate against the false acceptance rate for all possible operating points.

### DESCRIPTION OF THE PREFERRED EXAMPLE

Line features in a palm print contain various information including type, width, position, magnitude and orientation. The orientation information of the palm lines is used to identify the palm print of an individual. The identification method includes obtaining an image of a the individual's palm print, applying Gabor filters to the image to extract orientation information of the palm lines in six orientations and comparing the orientation information with palm line orientation information samples stored in a database. The comparison is undertaken by determining the angular distance between the extracted orientation information and the samples in the database. If the angular distance is zero a perfect match is found.

An apparatus and method for obtaining an image of an individual's palm print are described in Applicants earlier U.S. patent application Ser. Nos. 10/253,912 and 10/253,914, the contents of which should be considered included herein.

In the preferred embodiment orientation information in six orientations is found. In alternative embodiments the orientation information can be in two or more orientations.

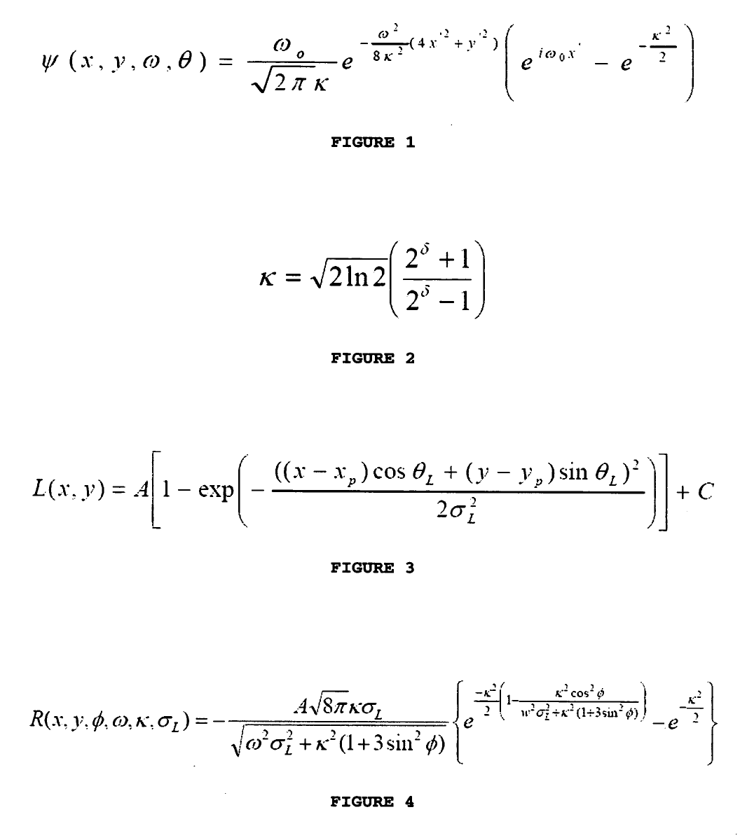

The orientation information is extracted using the neurophysiology-based Gabor function shown in FIG. 1. In the equation FIG. 1 x′=(x−x₀)cosθ+(y−y₀)sinθ, y′=−(x−x₀)sinθ+(y−y₀)cosθ; (x₀, y₀) is the center of the function; ω is the radial frequency in radians per unit length and θ is the orientation of the Gabor functions in radians. The κ is shown in FIG. 2. In the equations of FIG. 2 δ is the half-amplitude bandwidth of the frequency response, which, according to neurophysiological findings, is between 1 and 1.5 octaves. When σ and δ are fixed, ω can be derived from ω=κ/σ. This neurophysiology-based Gabor functions is the same as the general Gabor functions but the choices of parameters is limited by neurophysiological findings and the DC (direct current) of the functions are removed. A full discussion of neurophysiology-based Gabor functions can be found in T. S. Lee, “Image representation using 2D Gabor wavelet,” IEEE Trans. on PAMI, vol. 18, no. 10, pp. 959-971, 1996.

To design an explainable competitive rule for extracting the orientation information on the palm lines, an idea palm line model is constructed whose profile has an upside-down Gaussian shape. The idea palm line model is give by the equation in FIG. 3 where σ₁, the standard deviation of the profile, can be considered as the width of the line; (xₚ, yₚ) is the center of the line; A, a positive real number, controls the magnitude of the line, which depends on the contrast of the capture device; C is the brightness of the line, which replies on brightness of the capture device and the lighting of the capture environment and θ_{L} is the orientation of the line. Without loss generality, we set xₚ=0 and yₚ=0 for the following analysis.

To extract the orientation information on the palm lines, we apply the real part of the neurophysiology-based Gabor filters to the idea palm line model. The filter response on the middle of the line, xcosθ_{L}+ysinθ_{L}=0, is given by the equation in FIG. 4 where Ø=θ−θ₁. According to the equation in FIG. 4, we obtain the following properties.
Property 1: R(x,y,Ø,ω,κ,σ₁) reaches minimum when Ø=0
Property 2: R(x,y,Ø,ω,κ,σ₁)) is an increasing function with respect to Ø when 0<θ<π/2.
Property 3: R(x,y,Ø,ω,κ,σ₁) is a symmetry function with respect to Ø.
Property 4: R(x,y,Ø,ω,κ,σ₁) is proportional to A, the magnitude of the line.
Property 5: R(x,y,Ø,ω,κ,σ₁) is independent of C, the brightness of the line.
Property 6: R(x,y,Ø,ω,κ,σ₁)=0 when the orientation the filter is perpendicular to the orientation of the line.

The brightness of the line, C, is removed by the zero DC Gabor filters. However, according to the Property 4, the response is sensitive to the contrast of the capture devices. The goal is to obtain results that are completely independent of the contrast and the brightness of the capture devices. The feature codes holding these two properties are more robust to different capturing environments and devices. Thus, we do not directly use the response.

A rule, based on these six properties, for extracting palm line orientation information is defined as
arg minⱼ(I(x,y)*ψ_{R}(x,y,ω,Øⱼ))
where I is the preprocessed image; ψ_{R} represents the real part of ψ; Øⱼ is the orientation of the filters and j={0, . . . , J}.

The simple cells are sensitive to specific orientations with approximate bandwidths of Π/6 and so the following six orientations are chosen: Åⱼ=jΠ/6, where j={0, 1, . . . , 5} for the competition.

If we only extract the orientation information on the palm lines, we have to face two problems. Firstly, how do we classify a point that belongs to a palm line, and secondly even though we can have a good technique to classify the points on the palm lines the number of the extracted feature points may be different even for two palm print images belonging to the same palm. To avoid these two problems an assumption is made that each point on the palm print belongs to a palm line. Thus, the rule is used to code each sample point to obtain feature vectors with the same dimension.

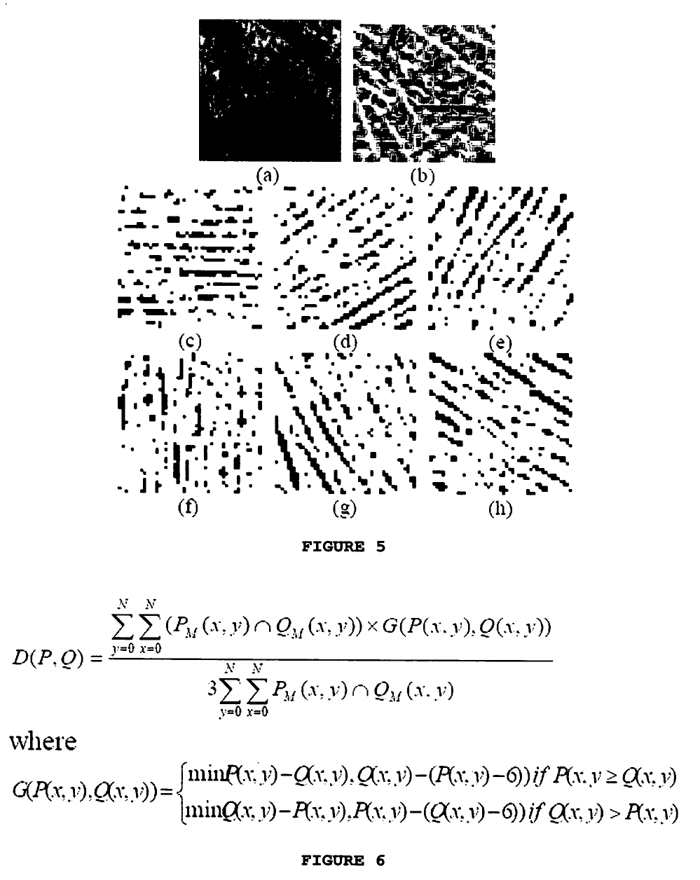

FIG. 5(a) is the original image of the palm and FIG. 5(b) is the coded image obtained from the equation of FIG. 4. FIGS. 5(c) to 5(h) show the six coded feature vectors for the six orientations respectively based on the rule arg minⱼ(I(x,y)*ψ_{R}(x,y,ω,Øⱼ). The code image FIG. 5(b) is highly related to the line features, especially for the strong lines, such as the principal lines of the six coded feature vectors FIGS. 5(c) to 5(h).

To implement a real-time palm print identification system, a simple and powerful palm print matching algorithm needed for comparing two codes. This is achieved by comparing the angular distance of the two codes.

Let P and Q be two codes and PM and QM be the corresponding masks of P and Q, respectively. The masks are used to indicate the non-palm print pixels described. The angular distance is defined by the equation in FIG. 6. In FIG. 6 ∩ represents an AND operator and the size of the feature matrixes is N×N. D is between 0 and 1. For prefect matching, the angular distance is zero. Because of imperfect preprocessing, we need to translate vertically and horizontally one of the features and then perform the matching again. Both the ranges of the vertical and the horizontal translation are −2 to 2. The minimum of the D's obtained by translated matching is regarded as the final angular distance.

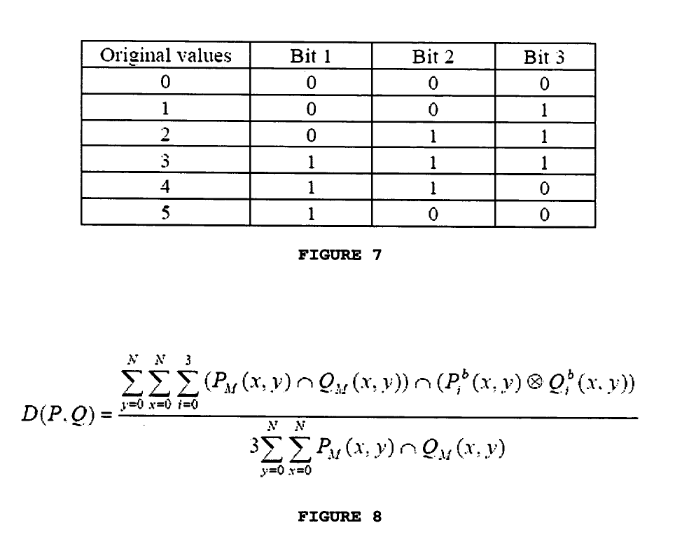

However, directly implementing the equation of FIG. 6 is ineffective. The elements of Competitive Code are 0, 1, 2, 3, 4 and 5. We can use three bits to represent an element and one bit for the mask. In total, a Competitive Code is constituted by four bit-planes. The bit values among different elements of Competitive Code are shown in the FIG. 7. According to this bit representation of the Competitive Code, a more effective implementation of angular distance can be defined by the equation in FIG. 8. In FIG. 8, Pᵢ^{b}(Qᵢ^{b}) is the i^{th} bit plane of P(Q) and \hat{×} is bitwise exclusive OR.

Using an ASUS notebook with an Intel™ Pentium III 933 MHz Mobile processor directly implementing the equation of FIG. 6 takes 2.27 ms for one matching, whereas the equation of FIG. 8 only takes 0.11 ms for one match. This bit representation is not only effective for matching but also effective for storage. In total, three bits are enough to keep the mask and one element of the Competitive Code. If a non palm print pixel exits at position (x,y), the corresponding three bits are set to 1, 0 and 1. As a result, the total size of the proposed feature, including the mask and the Competitive Code is 384 bytes.

In order to test the invention palm print images from 193 individuals were obtained. In the dataset, 131 people are male, and the age distribution of the subjects is: about 86% are younger than 30, about 3% are older 50, and about 11% are aged between 30 and 50. The palm print images were obtained on two occasions. Each time, the subjects were asked to provide 10 images from the left palm and 10 images from the right palm. Altogether, each person provided around 40 images, resulting in a total number of 7,752 images from 386 different palms. The average time interval between the first and the second collection was 69 days. The maximum and the minimum time intervals were 162 and 4 days, respectively.

To test the verification accuracy each palm print image was matched with all the other palm print images in the database. A matching is counted as a correct matching if the two palm print images are from the same palm; otherwise, the matching is counted as incorrect. The total number of comparisons was 30,042,876. None of the angular distances were zero. The number of comparisons that resulted correct matching is 74,068 and the rest of them were incorrect matching.

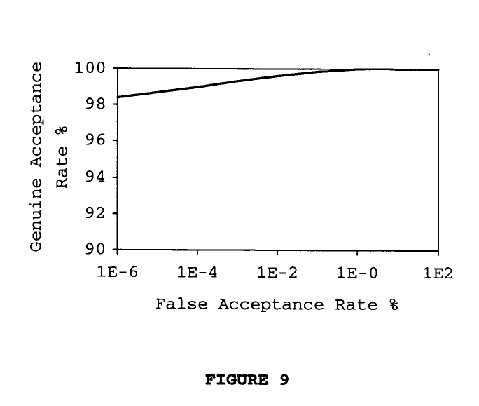

FIG. 9 depicts the corresponding Receiver Operating Characteristic (ROC) curve, as a plot of the genuine acceptance rate against the false acceptance rate for all possible operating points. In FIG. 9 it can be seen that the invention can operate at a genuine acceptance rate of 98.4% while the corresponding false acceptance rate is 3×10⁻⁶%

1. A method of biometrics identification including:
obtaining an image of a portion of a hand of a subject, said image including a line feature of the hand,
analyzing the image to obtain a characteristic value including orientation information of the line feature in two or more orientations,
comparing the characteristic value with reference information in a database.

2. The method of claim 1 wherein the characteristic value includes orientation information of the line feature in six orientations.

3. The method of claim 1 wherein the step of analyzing the image includes using a Gabor function to obtain the characteristic value.

4. The method of claim 1 wherein the step of analyzing the image includes using a Gabor function of the form
$$ψ ( x , y ω , θ ) = \frac{{ω}_{0}}{\sqrt{2 πκ}} {ⅇ}^{- \frac{{ω}^{2}}{8 {κ}^{2}} ( 4 {x}^{′2} + {y}^{′2} )} ( {ⅇ}^{{ⅈω}_{0} {x}^{′}} - {ⅇ}^{- \frac{κ2}{2}} ) .$$

5. The method of claim 1 wherein the step of analyzing the image includes creating a model of the line feature, said model having the form
$$κ = \sqrt{2 ln 2} ( \frac{{2}^{δ} + 1}{{2}^{δ} - 1} ) .$$

6. The method of claim 1 wherein the step of analyzing the image includes:
creating a model of the line feature,
applying a Gabor function to the model to extract properties of the line feature, and
applying a rule to the properties to obtain the orientation information.

7. The method of claim 1 wherein the step of analyzing the image includes:
creating a model of the line feature,
applying a Gabor function to the model to extract properties of the line feature, and
applying a rule to the properties to obtain the orientation information, the rule having form
arg minⱼ(I(x,y)*ψ_{R}(x,y,ω,φⱼ)).

8. The method of claim 1 wherein the step of comparing the characteristic value with reference information includes calculating an angular distance between the characteristic value and reference information.

9. The method of claim 1 wherein the step of comparing the characteristic value with reference information includes calculating an angular distance between the characteristic value and reference information, said angular distance having the form
$$D ( P , Q ) = \frac{{\sum }_{y = 0}^{N} {\sum }_{x = 0}^{N} ( {P}_{M} ( x , y ) ⋂ {Q}_{M} ( x , y ) ) \times G ( P ( x , y ) , Q ( x , y ) )}{3 {\sum }_{y = 0}^{N} {\sum }_{x = 0}^{N} {P}_{M} ( x , y ) ⋂ {Q}_{M} ( x , y )} .$$

10. The method of claim 1 wherein the step of comparing the characteristic value with reference information includes calculating an angular distance between the characteristic value and reference information, said angular distance having the form
$$D ( P , Q ) = \frac{{\sum }_{y = 0}^{N} {\sum }_{x = 0}^{N} {\sum }_{i = 0}^{3} ( {P}_{M} ( x , y ) ⋂ {Q}_{M} ( x , y ) ) ⋂ ( {P}_{i}^{b} ( x , y ) ⊗ {Q}_{i}^{b} ( x , y ) )}{3 {\sum }_{y = 0}^{N} {\sum }_{x = 0}^{N} {P}_{M} ( x , y ) ⋂ {Q}_{M} ( x , y )} .$$
